(19) United States
(12) Patent Application Publication
(10) Pub. No.: US 2005/0062603 A1
(43) Pub. Date: Mar. 24, 2005

(54) Secure, networked and wireless access, storage and retrival system and method utilizing tags and modular nodes

(76) Inventors: Oren Fuerst, New York, NY (US); Tzameret Fuerst, New York, NY (US)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/911,525

(22) Filed: Aug. 5, 2004

Related U.S. Application Data
(60) Provisional application No. 60/492,778, filed on Aug. 6, 2003.

(51) Int. Cl. G08B 1/08

(52) U.S. Cl. 340/539.12; 340/539.13

(57) ABSTRACT

A system apparatus and method of monitoring in a secured fashion the access, storage and retrieval of information, using a networked modular wireless device. The system may include a network of wireless, Wi-Fi devices (or any other wireless communication mechanism such as GPRS, GSM, iDen), or Nodes, each one of them possibly controlling the access to a medically sensitive object, such as a drawer (or cabinet) or to a medical device, or to another information source, item of equipment, drug, etc as well as tracking via RFid readers the access to the records or information contained in it. In the case of a physical file, each file has an RFid tag on it that is being read when removed or returned to the cabinet. Access to the cabinet and physical records, or to the medical device is monitored by reading the RFiD identity card of personnel accessing the cabinet or medical devices. In addition to controlling the access to the cabinet or medical device by controlling the cabinet lock (or in the case of a small medical device, the lock of an IV, injection device, specimen collection unit, or of a large medical device such as a defibrillator), the node can alert electronically by sending a message to the controlling unit, or by sending a physical alert (such as an alarm signal), when unauthorized personnel is attempting to access the cabinet, the files or devices. The system is useful in the context of monitoring the information contained in physical files, such as medical information, and can be used for access to medical devices, in order to better monitor the authorization rights of personnel participating in processes such as drug delivery or specimen collection. A control unit monitors activity at a plurality of nodes, and assists in storing the list of authorized personnel and files, and can store electronically captured information regarding the physical files (for example, the reason for accessing the file and reasons for changes in it) or medical device. The system can communicate with other information management systems.

### CROSS-REFERENCE TO RELATED APPLICATIONS

This application claims the benefit of prior filed provisional patent application 60/492,778, with filing date Aug. 6, 2003, incorporated herein by reference in its entirety.

### FIELD OF THE INVENTION

An embodiment of the present invention relates to an electronically secured access to non-electronically and non-digitally stored information and databases containing physical files such as paper and other storage mediums which are either manually, mechanically or otherwise accessible, including medical devices. In particular, the embodiments of this invention relates to data, databases and industries that are required to comply with heightened privacy and security requirements with regard to the access to, use of and monitoring of stored information in their possession or under their control such as the healthcare industry under the laws known as HIPAA, as further detailed herein.

### BACKGROUND

Healthcare service providers, as well as other service providers, such as financial and legal service providers, store a wealth of information regarding their customers in order to provide an adequate level of service. For example, in the healthcare services settings, patients are required to fill up forms addressing issues such as their historical health issues, including allergies, operations, etc. In addition, additional information that is received or created throughout the healthcare service process, such as laboratory results, doctors' and nurses' evaluations, prescriptions, etc., might be stored in a physical form, including paper, cardboard, charts and pictures.

Record-keeping requirements imposed on healthcare service providers raise a myriad of issues and, in particular, in light of HIPAA regulations. The new HIPAA laws and regulations pose major risks to organizations maintaining physical and virtual (computer stored) medical records. HIPAA, the Health Insurance Portability and Accountability Act of 1996, and its resulting rules are now going into effect in steps and pose strong requirements for the privacy of Protected Health Information (PHI). Whether electronic or paper-based, documents containing PHI are now the subject of strict privacy regulations.

Compliance with HIPAA is expected to alter the way health information is stored, accessed and communicated, but while expected efficiencies abound, estimates of the its cost, industry-wide, exceed $40Bn. Most participants in the healthcare industry are affected by the HIPAA set of laws and regulations. Most providers (including over 50,000 private physician offices and 5,500 hospitals), payers (including over 25,000 self-insured health plans) and data clearinghouses are described by the regulations as “Covered Entities” and industry-related professionals are described as “Business Associates” (including 10,000s of services providers to the industry). The penalties for non-compliance are greatest for the Covered Entities, and they also have strong incentives to police their respective Business Associates. Federal penalties for non-compliance start at $100 per incident per day with a maximum fee of $25,000 per incident with up to 10 years of imprisonment, and could even be surpassed by State and civilian penalties. Covered entities and their Business Associates have a strong incentive to adopt solutions to help them comply with HIPAA regulations.

In order to comply with HIPAA, clinics, hospitals, laboratories and insurance companies all have to put stricter controls on their medical paper-based records filing systems. The systems need to limit access to files to authorized personnel and track the circulation of files, while keeping costs low and productivity high. Traditionally larger organizations have been implementing a manual, or at best a semi-computerized filing system (with manual checking in/out procedures and expensive file-room personnel), while smaller organizations have done very little to secure and manage their file system. This resulted in misplaced and lost records. With HIPAA taking effect, this lack of security becomes also a serious legal liability and a significant financial risk.

Medical software designers now need to satisfy the new HIPAA regulations that specify, for example, a) patient access to their medical records, b) patient consent to the distribution of their medical data, c) patient restrictions on the distribution of their medical data, d) patient education about their privacy rights under these regulations, and e) the ability of the patient to amend their medical record. While numerous products in the marketplace attempt to address the HIPAA requirements for electronic records, most procedures for physical files remain manual. Furthermore, commonly there is no link in the computer system between the patient's electronic and physical files. In particular, there is a need for a solution for physical files access, retrieval and change monitoring for physical files. The invention described here provides physical health/medical records the security and privacy measures similar to those available to electronically captured records.

In recent years, the issue of reducing one of the nation's leading causes of death and injury—medical errors—became a central one in the U.S. healthcare system. In particular, the reduction of medical errors requires rigorous changes throughout the health care system, including mandatory reporting requirements, says a report (“to err is Human”) from the Institute of Medicine (IOM) of the National Academies. The report lays out a comprehensive strategy for government, industry, consumers, and health providers to reduce medical errors, and it calls on Congress to create a national patient safety center to develop new tools and systems needed to address persistent problems. The human cost of medical errors is high. For example, various studies estimate that medical errors kill 40,000-90,000 people in U.S. hospitals each year. In fact, more people die from medical mistakes each year than from highway accidents, or AIDS.

While errors may be more easily detected in hospitals, they have a tremendous impact on every health care setting: day-surgery and outpatient clinics, retail pharmacies, nursing homes, as well as home care. For example, 7,000 deaths from medication errors that take place both in and out of hospitals exceed those from workplace injuries. Therefore, a system to reduce medical errors would be valuable to the healthcare system.

Setting up of a secured method of access control for physical records requires an expensive setting up and high ongoing maintenance costs. Such costs are high when the access control devices are independent, as each one of them must retain the full list of authorized personnel. The costs are also high when the access control devices are networked using traditional networking methods. These costs relate to the high cost of networking, including the cost of network cables, router and network configurations, and the high costs of replacing item that malfunction on the network

While the above-mentioned problems relate to medical records, similar problems exist with respect to other types of records, such as, for example, legal and financial documents, as well as any other types of documents. or records that need to be securely maintained, accessed, and/or controlled. These types of documents and others often suffer from similar problems to those listed above in the medical-records context. Therefore, a secure records storage and retrieval system and method that eliminate the disadvantages mentioned above are needed.

### SUMMARY OF THE INVENTION

An embodiment of the present invention relates to information security of records systems and, more particularly, but without limitation, to a method of and system for accessing, storing, retrieving and tracking the changes in medical records, by using a combination of a centralized computer possibly controlling or communicating with, for example, a network of wirelessly connected nodes that monitor activity within and around filing cabinets and medical devices.

An embodiment of the Invention is comprised of a system, apparatus and method of monitoring in a secured fashion the access, storage and retrieval of information, using a networked modular wireless device. The system includes a network of wireless, Wi-Fi devices (or any other wireless communication mechanism such as GPRS, GSM, iDen), or Nodes, each one of them possibly controlling the access to a medically sensitive object such as a drawer (or cabinet) or to a medical device or to another information source, item of equipment, drug, etc, as well as tracking the access by using tracking devices associated with users of the system such as via RFid readers or other radio devices, or other suitable tracking devices to the records or information contained in it.

In the case of a medically sensitive object such as a physical file, each file may have a tracking device such as a RFiD tag attached or associated with it that may be read when removed or returned to the cabinet. Access to the cabinet and physical records or to the medical device is monitored by reading the user-associated tracking device identity device of the personnel accessing the cabinet or medical devices. In addition to controlling the access to the storage device or medical device by controlling the storage device lock (or, for example, in the case of a small medical device such as the lock of an IV, injection device, specimen collection unit, or possibly a lock of a large medical device such as a defibrillator), the node may electronically alert, for example, by sending a message to a controlling unit, or by sending a physical alert (such as an alarm signal), when unauthorized personnel is attempting to access the storage devices, the files or devices.

A system according to an embodiment may be useful in the context of monitoring the information contained in physical files, such as medical information, and can be used for access to medical devices, in order to better monitor the authorization rights of personnel such as personnel participating in processes such as drug delivery or specimen collection.

A controller or a control unit monitors activity (that may be received from for example one or more nodes), and assists in storing the list of authorized personnel and files, and can store electronically captured information regarding the physical files (for example, the reason for accessing the file and reasons for changes in it) or medical devices. The system may be able to communicate with other information management systems.

An embodiment of the Secured Protected Health Information Network may provide an innovative solution that could become a central piece in an organization's plan to provide high security and privacy level for PHI at its possession. The system may provide a vehicle to allow hard copies such as paper-based records, comparable levels of protection to those available to electronic ones, and to add a provisioning security layer to medical treatments involving activities such as medication and specimen collection. The same platform could also be used for information tracking regarding medications and other medical supplies, and could also be used in other contexts where tracking access to assets is essential.

An embodiment of the system may be based on a network of modular Nodes, which are controllers or computers (potentially ruggedized) on a chip with embedded access control devices such as RFID readers and piezo electric keypads, that can control retrofitted storage devices such as cabinets/locks and medical devices such as injection tools. In one embodiment, the Nodes may be controlled by a small footprint Command Unit, and deliver a hardened access control and tracking solution that helps organizations comply with the new HIPAA privacy standards. An embodiment of the system may identify and record the position and locations of users and stored files or other medically sensitive objects and process them. In addition to controlling the Nodes, the Command Unit may control peripheral devices such as RFiD printers (e.g. Zebra) and could interface with 3^{rd} party access control and medical data management systems.

A system according to some embodiments may include software tools to provide authorization and file tracking management, and will have an API to seamlessly connect with existing authorization, provisioning and record management systems (such as MS Active Directory, LDAP, CA eTrust and Lenel OnGuard, Cerner CapStone).

Each Node may for example read the tracking devices associated with users (such as RFiD ID card or other tracking units), optionally requiring such user to enter a pass-code to open the locks of the physical storage device (for example a file cabinet), and, after receiving authorization, allow said user to open the physical storage device. Patient or other files or records carrying suitable record associated tracking device (for example, a small RFiD tags) on them are then may be recognized by the system when being removed from returned to the physical storage device. The embodied system may also inquire the user for the reasons for the access of information, and allows for marking of cases and recording where the information in the file is being altered. In an embodiment of the system, the system may assemble compare and produce reports of all movements or changes in the locations of the user and record tracking devices, their relative positions and changes made in the content of the records.

The Nodes that may be included in the system combine the flexibility of RFiD, which unlike bar code readers does not require a line of sight and can read multiple tags simultaneously, and allows for a quick and seamless handling of files. Even more so, RFiDs can store various kinds of data, including authentication material. The Nodes offers a modular approach, whereby the units may have in their design the ability to incorporate different types of identification devices, for records and personnel, as well as supplemental means of personnel authentication and verifications, such as fingerprinting scanner.

A Command Unit that may be included in the system may store a list, or a database (or obtains information from external databases), of users and their associated authorization right and clearance to access particular records. The command unit may provide an audit trail of the history of accessing the stored records (such as patient files and records), as well as reasons for altering the files. The said command unit may also allow for the connection with external software systems, for example to the electronic documents data management software the organization might be using already.

### BRIEF DESCRIPTION OF THE DRAWINGS

A more complete understanding of exemplary embodiments of the present invention can be achieved by reference to the following Detailed Description of Exemplary Embodiments of the Invention when taken in conjunction with the accompanying Drawings, wherein:

FIG. 1 is a diagram of an embodiment of a Secure, Networked and Wireless Records Access, Storage and Retrieval System and Method Utilizing Tags and Modular Nodes in accordance with an embodiment of the present invention; and

FIG. 2 is a flowchart describing a method according to one embodiment of the invention.

### DETAILED DESCRIPTION OF EXEMPLARY EMBODIMENTS OF THE INVENTION

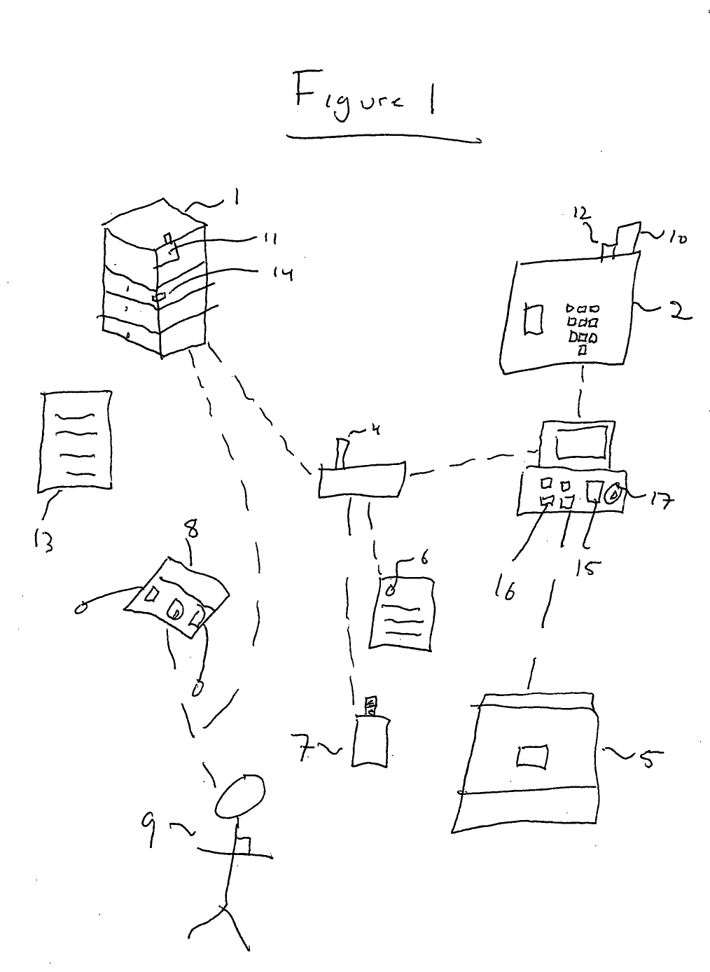

In the following Detailed Description of Exemplary Embodiments of the Invention, for purposes of explanation and not limitation, specific details are set forth in order to provide an understanding of an embodiment of the present invention. Preferred embodiments of the present invention are best understood by referring to FIG. 1. However, it will be apparent to those of ordinary skill in the art that the present invention can be practiced in other embodiments that depart from these specific details. In other instances, detailed descriptions of well-known methods, devices, logical code (e.g., hardware, software), etc are omitted so as not obscure description of the embodiment of the present invention with unnecessary detail. In particular, even though examples discussed in the following Detailed Description are largely in the context of medical records, embodiments of the present invention can be practiced in a wide variety of contexts, including, but not limited to, legal, industrial and other contexts. Furthermore, although some of the examples discussed above are in the context of healthcare personnel accessing a patient's records, it should be understood that embodiments of the present invention encompasses any participant authorizing any other participant to access records. In addition, it will be understood that the present invention is not limited to the embodiment(s) disclosed, but is capable of numerous rearrangements, modifications, and substitutions without departing from the spirit of the invention. In addition, while the illustration is for medical records, similar approaches could be deployed for controlling the providing of medical treatment such as specimen collection and injections. In particular, the same authorization rights and control of cabinet locks could be used for controlling the lock of an injection device. In that context, a nurse will not be able to inject to a patient a particular formulary without having authorization rights to that activity for that patient. In addition, the device will not allow for the injection without a fit between the patient and the particular device.

In general, embodiments of the system and method may be useful for tracking the access to, retrieval of, and changes in records at one or more physical storage device such as the filing cabinets 1 (all items hereunder referred to are as shown in FIG. 1), using, for example, wireless access control 4 and monitoring units 2, labeled Nodes. In addition to the tags on the records 6, there are tags 7 with the personnel accessing the records 13. The identification information on the personnel tags 7 and record tags 6 is compared to authorization rights tables residing within a command unit 3, to which the Nodes 2 are connected. In an alternative setting, a data table resides with the Node's 2 processing units, to allow for disconnected mode. The stored records may be or include medically sensitive objects and information.

Each document tag 6 and personnel tag 7 may include at least an electronic memory coupled to an antenna by which information from the memory may be transmitted and/or information may be received and stored in the memory. Nodes 2 also have the ability to read and/or write to the tags 6 and 7 and may have some antennas 10 that can for example allow the reading and writing to and from the tags 6 and 7, and communicate with the Command units 3 and/or other Nodes 2, either directly (via ad-hoc networking), or via wireless access points, if connectivity is provided by way of wireless communication such as a wireless router 4.

The process described in FIG. 1 allows for the issuing of one or more tags coded with related information 6 and 7. The tag can be for example a tag for a document 6, or a personnel tag 7. The issuance process could be done on the same unit or using different issuing units. For example, the personnel tag 7 could be the same tag used for other access control systems in the organization, and could be issued using a laminated card, relative to a record tag that could be printed using for example, a standard RFiD bands printer 5 (such as the one produced by Zebra).

Records 13 that carry tags, as well as other records, could be stored in filing cabinets 1 that are monitored by Nodes 2. The node 2 might be physically attached to the cabinet and control the cabinet's security device, for example a lock or electronic code-pad, as shown in Items 1 and 11, or be attached as a monitoring device, without physical access control over the cabinet as item 2 shows. A Node 2 may also have an alert mechanism such as an alarm device, which will control a buzz or a voice alerting about unauthorized access to the cabinet and/or particular file.

The security device may include locking mechanism 14 of the file cabinets may be comprised of an electro-mechanic reactive device, in which a signal transmitted to the device operates a dual position mechanic latch which in one position mechanically prevent the opening the cabinet and in the other position allow the physical opening of said cabinet.

The Node can recognize the personnel 9 accessing the cabinet 1 and files 13 by automatically recognizing his/her tag 7 (be it RFiD or bar coded or other recognition device), as well as by other, less automatic means. For example, by fingerprinting or access code, both of these tools being deployed on the Node 2 and 11. Additional mechanisms of verifications could be used, such as Proximity card of different types. These tools could be used separately, or in any combination, based on the preference of the implementing organization.

The Node as shown in Item 2 may have additional keys on it, to provide additional functionality for the personnel accessing the cabinet and files. For example, the node may have keys that the personnel 9 will have to press if the record was altered, or if a new paper was added to the file. Similar functionality could be added via the command unit 3, or any other devices connected to the network.

Whenever personnel 9 gets close to the cabinet 1, the Node 2 reads the information in the personnel tag and compares the identity of the personnel to the authorization rights associated with this particular cabinet 1. If the person is authorized to access the cabinet, a green signal (a signal that may unlock or provide access to a file cabinet (and physical opening of the cabinet) will be provided.

If the person accessing the cabinet is not authorized to access the cabinet, the Node 2 and/or 11 may not allow the cabinet lock 14 to open, or may buzz if any record 13 is taken from the cabinet by the unauthorized person. Each file that is being taken out of the cabinet is examined against a data table of authorized personnel to handle this record. A computerized notice may be made, or an alarm may be heard in cases where the policies are being violated. The command unit 3 may handle the authorization tables, and allows for additional data entry to be associated with specific personnel and/or records. For example, an audit trail may be added to each record, associating the person accessing the file with changes in the record that are being made. The communication between the Nodes 2 and the Command unit 3 could be done using wireless standard that are commonly used in networked settings, such as 801.11 on its different flavors (such as 801.11a; 8011.11b and 801.11g) (Item 4 demonstrates a standard wireless router using 801.11 network setting that may be used).

The embodied system may be able at any given time upon request from authorized supervisors and on a recurring and periodical basis to indicate the locations and positions of all tracked files and tracked users, the changes made to any file since the last report and historical reports as to all changes made to any file including the date and nature of change and which user performed any such change. The embodied system may also generate reports as to violations or attempted violations of the authorization and cases of unauthorized access.

The Node 2 and 11 may be of a modular design, allowing for easy replacement of its components. In particular, the design may allow for the addition of a keypad for password entry, as well as for the incorporation of additional keys such as “Record Change” and “Record View Only” buttons, to reflect the activities by the personnel with respect to the record.

The Node 2 and 11 may include both wireless ability, as well as a standard Ethernet jack, for connection to the network via cable in cases where wireless connectivity is not available or desirable.

The system Nodes 2 and 11 may also be based on alternative designs. For example, on their web site, Intel reports that it has designed a “Mote”, a small, modular, stackable design. Intel Research is using the Zeevo module on the main board (containing an ARM1 core, SRAM and Flash memory, and Bluetooth wireless technology), an optional power supply regulator, and sensor boards. The mote platform can accommodate other features as well, such as alternate radio, debug and actuator boards. A backbone interconnect provides power and bidirectional signaling capability. Intel Mote software is based on Tiny OS, a component-based operating system designed for deeply embedded systems that require concurrency-intensive operations and which have minimal hardware resources. The software stack includes an Intel Mote-specific layer with Bluetooth support and platform device drivers, as well as a network layer for topology establishment and single/multi-hop routing. Such mote could be incorporated within the Node 2 and 11.

While in the description above communication is over Wi-fi (8011.11) standards, communication between the Nodes 2 and 11 and between the Nodes 2 and 11 and the command unit 3 could be conducted over regular suitable communication means including but not limited to wire, cable, optical fiber, local area network (LAN), wide area network (WAN), Bluetooth, radio (RF) transmission, optical transmission or other suitable means, or any combination thereof, with or without one or more wireless access point communication hubs. The communication could be in real time, or be in batch mode and may include one or more means of communications and/or communication standards.

Leveraging its modular approach, the Node 2 and 11 could accommodate various devices and security devices controlled by it. For example, an injection device could be enabled (by being released from a security device attached or being part of the Node) for operation only once an authorized personnel's tag 7 is recognized by the Node 2 and 11. Similarly, if the node is small enough, (for example, by using a Node along the lines of the Intel Mote described above), the Node itself, could become part of the controlled device. Or example, an External Defibrillator 8 (such as the Medtronic LIFEPAK® 500 configured with a built-in Node that cannot be enabled for operation unless the personnel is authorized for operating such a machine that could do harm if operated by unskilled personnel. RFID tags 6 and 7 that are being used as an illustration of the invention are typically utilized for tagging and electronically identifying articles by reading information stored in the electronic memory of the smart tag using contact-less radio-frequency (RF) transmissions. Available smart tags operate at RF frequencies between hundreds of kilo-Hertz (KHz) and several giga-Hertz (GHz). Typical frequencies for RF smart tags and smart cards (functionally the same but different in form) include 125 KHz, 13.56 MHZ, 915 MHZ and 2.45 GHz. Typically, an electronic integrated circuit in the form of a semiconductor chip is connected to an antenna ANT on a substrate to serve as a tag. The semiconductor chip typically includes a processor and an electronic memory for storing information. Information stored in a smart tag can be read by a suitable smart tag reader and can be read and written to by a suitable reader/writer. The reader or reader/writer and the tag antenna are tuned suitably so that RF energy (electromagnetic fields and electrical signals) can stimulate the tag to emit a signal representative of the information (electronic codes or data) stored on the tag memory. Such contact-less RF tags eliminate the need for an electrical contact or a line-of-sight path for communication with the smart tag.

Suitable processors for the Node 2 and 11 and Command Unit 3 may include any modern personal computer (PC) or controller, such as those having a Pentium.RTM., Celeron.RTM., or similar processor 15, running a Windows, Linux or other PC operating systems. Where a WLAN or LAN network is employed, standard PC networking hardware and software may be included in the PCs. Desirably, the processors, as well as the smart tag control units readers/writers, will have redundant memory 16 and information storage, such as by one or more of non-volatile memory, a hard disk drive 17, a floppy disk drive, a CD-write drive and the like. The command unit can also control a tag issuance device, such as the zebra RFiD tag printer 5. The command unit may be able to communicate with external databases and systems, including, and without limitations, the organization's personnel database, and the patients' electronic records systems.

Applications programs suitable for recording and manipulating the information include relational database software such as the Windows based Microsoft SQL 2000 or ACCESS databases as well as other databases platforms such as ORACLE, MySQL database software, and software languages such as Visual Studio C#, Java, or other computer language.

Each database record may typically include some or all of the following fields of information: The record identification key, the Node 2 and 11 and/or activity identification, cabinet entry and exit time data, date, keypad/keyboard entered data (such as information about changing the record, an/or reason for viewing it), personnel tag information. Thus, the database maintains an inventory of the records and personnel, their activities and locations. Typically, the database software interfaces with other standard software the organization utilizing the system is using for storage of medical and/or personnel information.

As a preferred embodiment, the Tags 6 and 7 may be utilized by reading information stored in the electronic memory of the tag using contact-less radio-frequency (RF) transmissions, otherwise known as RFiD tag. For the embodiment of the present system and method, an electronic integrated circuit in the form of a semiconductor chip is connected to an antenna on a substrate to serve as a tag. The semiconductor chip typically includes a processor and an electronic memory for storing information. Information stored in a tag can be read by a suitable tag reader and can be read and written to by a suitable reader/writer. The reader or reader/writer and the tag antenna are tuned suitably so that RF energy (electromagnetic fields and electrical signals) can stimulate the tag to emit a signal representative of the information (electronic codes or data) stored in the tag memory. Such contact-less RF tags eliminate the need for an electrical contact or a line-of-sight path for communication with the smart tag. Alternatives could be using systems such as barcodes, or other systems, such as color coding.

Each database record may typically include fields for some or all of the following application specific data or information in addition to the patient or employee identification number: Record information including but not limited to the identification of the record, the time of record creation, the date of record expiration, an audit trail of accessing the record, the identity of personnel accessing the record, the reasons for accessing the record, the length of time the record was kept out of the cabinet, the files and records types the personnel is authorized to access and/or alter, the node 2 and 11 from which the record was accessed.

In the case of controlling medical devices (such as the one in Item 8), the records may include items such as the skill set of the personnel, the risk level of the medical device being controlled, and the duration of operation of the device. Such items could allow for both tracking of usage of the equipment, but also for comparing authorization level of the personnel utilizing a particular piece of equipment with the authorized group for using such medical device.

While some of the information may be stored on the physical record (or personnel card) tag, the entire history of the activities related to the tag may be stored at the command unit or linked hardware devices.

While the present invention has been described in terms of the foregoing example embodiments, variations within the scope and spirit of the present invention will be apparent to those skilled in the art. For example, many different combinations of the form of identifications (be it RFiD tags, bar code or Prox card), antennas, reader/writer units, communication devices and processors, as well as the communication standards (be it Wi-Fi, Bluetooth or another) may be employed in making and using the system and in practicing the method described herein. Such communication methods could be used for communication between the nodes 2 and 11 and the nodes and the command unit 3.

It should be noted that the Nodes 2 and 11 may include any number of Nodes as may be necessary, convenient or desirable. The Nodes need not be located in proximity to each other, and could potentially be even at different locations and even widely dispersed geographically, and need not be under the ownership and/or control of any one person or entity. The Nodes (Item 2) can be connected using the communication network of the organizations, or using a secured channel (for example by utilizing VPN technologies) over public communications infrastructure such as the internet.

Depending on the interface component mounted on the Node 2, the node in the described embodiment of the present invention can also operate as a device that complies with the Wi-Fi protocol and/or the Blue Tooth protocol to allow the device to be part of a wireless LAN (Local Area Network). It will be readily understood that part or all of the protocols may also be stored in memory located on the Node.

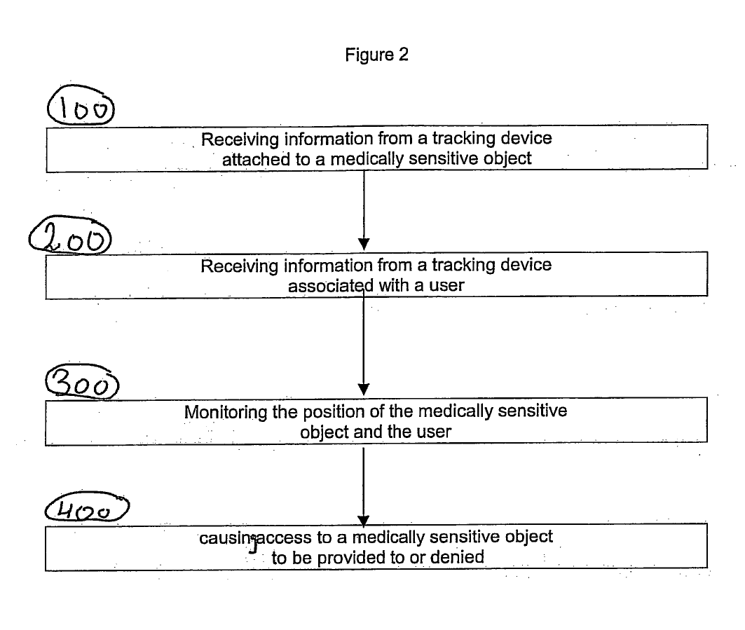

FIG. 2 is a flowchart describing a method according to one embodiment of the invention. In block 100 a unit (e.g., a controller, such as a central controller) may receive information from a tracking device attached to a medically sensitive object. Such information may be recorded, for example, by a node and separate from the controller, or may be received directly by the controller. In block 200 the controller may receive information from a tracking device associated with a user. In block 300 the controller may monitor the position of the medically sensitive object and the user. In block 400 the controller may cause access to a medically sensitive object to be provided to or denied to a user. Other steps or series of steps may be used.

It is to be understood that the embodiments of the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on-a controller or computer platform having hardware such as one or more central processing units (CPU) 15, a random access memory (RAM) 16, and input/output (I/O) interface(s). The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components, or the method steps, may differ depending upon the manner in which the embodiment of the present invention is programmed. One of ordinary skill in the related art will be able to contemplate these and similar implementations or configurations of the embodiment of the present invention.

The medical record may be constructed as an account used to collect messages including medical information about the patient and the personnel accessing the file. The software may look up the medical record using for example, a Lightweight Directory Access Protocol (LDAP) or Active Directory (AD) server, who the user accessing the record is, and if s/he has access or other rights associated with the record. Different software tools for provisioning could be used, for example software tools such as those offered by Business Layers. Such software tools can provide employees, business partners, and contractors with the appropriate level of access to digital resources, and bar access when no longer needed. All user accounts are automatically established, maintained, and cut off in a consistent and timely manner with proper authorizations, audit tracking, and escalation. In addition, such eprovision Software employs the latest open technologies, including LDAP directories and XML profiles, making it easy to deploy customized provisioning/deprovisioning solution in stages, and to quickly adapt the solution to ever-changing business requirements.

Various medically sensitive objects (e.g., files, physical or otherwise, filing cabinets, medical devices, drugs, etc.) may be tracked (e.g., using tracking devices such as RFID tags, radio monitors, etc.) and/or controlled (e.g., using security devices such as electromechanical locks, servos, radio controlled or otherwise controlled devices) using embodiments of the system and method of the present invention.

Having described embodiments for system and method providing a secured interface between users in a health care environment capable of providing communication and audit functionality, it is noted that modifications and variations can be made by persons skilled in the art in light of the above teachings. It is therefore to be understood that changes may be made in the particular embodiments of the invention disclosed which are within the scope and spirit of the invention.

1. A method comprising:
receiving information from a tracking device attached to a medically sensitive object;
receiving information from a tracking device associated with a user; and
monitoring the position of the medically sensitive object and the user.

2. The method of claim 1, wherein the medically sensitive object is a medical file including documents.

3. The method of claim 1, wherein the medically sensitive object is a medical device.

4. The method of claim 1, wherein each tracking device is an RFID tag.

5. The method of claim 1, comprising recording a position of a set of users relative to a set of medically sensitive objects.

6. The method of claim 1, comprising setting a security device based on said received information.

7. The method of claim 6, wherein said security device is a lock.

8. The method of claim 6, wherein said security device is a lock on a filing cabinet.

9. The method of claim 6, wherein said security device is a lock on a medical device.

10. The method of claim 1, comprising producing a report on a medically sensitive object's location relative to a person.

11. The method of claim 1, comprising storing a set of authorizations, and based on the information and the authorizations, preventing or allowing access to a medically sensitive object.

12. A device comprising:
a controller to receive information from a tracking device attached to a medically sensitive object, to receive information from
a tracking device associated with a user, and to monitor the position of the medically sensitive object and the user.

13. The device of claim 12, wherein the medically sensitive object is a medical file including documents.

14. The device of claim 12, wherein each tracking device is an RFID tag.

15. The device of claim 12, wherein the controller is to set a security device based on said received information.

16. The device of claim 15, wherein said security device is a lock.

17. The device of claim 16, wherein said security device is a lock on a medical device.

18. The device of claim 12, comprising a set of authorizations, wherein, based on the information and the authorizations, the controller is to prevent or allow access to a medically sensitive object.

19. A method comprising:
accepting information on the location of each file in a set of files;
accepting information on the location of each user in a set of users; and
setting an access permission to the set of files based on a set of authorizations and the information received.

20. The method of claim 19, wherein the information on the location of the set of users is received from radio devices.

21. The method of claim 19, wherein setting an access permission includes operating a lock.
